(19) United States
(12) Patent Application Publication
(10) Pub. No.: US 2007/0238849 A1
(43) Pub. Date: Oct. 11, 2007

(54) Durene isocyanate-based elastomers for golf ball layer compositions

(76) Inventors: Shenshen Wu, Shrewsbury, MA (US); Kevin M. Harris, New Bedford, MA (US)

Correspondence Address: BINGHAM MCCUTCHEN LLP, 2020 K Street, N.W., Intellectual Property Department, WASHINGTON, DC, 20006, US

(21) Appl. No.: 11/400,700

(22) Filed: Apr. 10, 2006

(51) Int. Cl. C08G 18/00

(52) U.S. Cl. 528/44

(57) ABSTRACT

Golf balls incorporating light stable polyurethane-based and polyurea-based compositions that include durene isocyanates and/or tertiary isocyanates in the prepolymer, wherein the prepolymer is the reaction product of a durene isocyanate and/or a tertiary isocyanate and a polyol or amine-terminated compound (depending on the end product desired) that has been cured with an amine-terminated or hydroxyl-terminated curing agent.

### FIELD OF THE INVENTION

The invention relates to golf equipment formed from polyurethane-based and polyurea-based compositions that incorporate durene isocyanates and/or tertiary isocyanates in the prepolymer. In particular, the present invention is directed to a composition for golf equipment that includes a prepolymer, which is the reaction product of a durene isocyanate and/or a tertiary isocyanate and a polyol or amine-terminated compound (depending on the end product desired) that has been cured with an amine-terminated or hydroxyl-terminated curing agent. The polyurethane-based and polyurea-based compositions of the invention have improved light stability.

### BACKGROUND OF THE INVENTION

Golf equipment, i.e., clubs and balls, are formed from a variety of compositions. For example, golf ball covers are formed from a variety of materials, including balata and ionomer resins. Balata is a natural or synthetic trans-polyisoprene rubber. Balata covered balls are favored by more highly skilled golfers because the softness of the cover allows the player to achieve spin rates sufficient to more precisely control ball direction and distance, particularly on shorter shots.

However, balata covered balls are easily damaged, and thus lack the durability required by the average golfer. Accordingly, alternative cover compositions have been developed in an attempt to provide balls with spin rates and a feel approaching those of balata covered balls, while also providing a golf ball with a higher durability and overall distance.

Ionomer resins have, to a large extent, replaced balata as a cover material. Chemically, ionomer resins are a copolymer of an olefin and an α,β-ethylenically-unsaturated carboxylic acid having 10 to 90 percent of the carboxylic acid groups neutralized by a metal ion, as disclosed in U.S. Pat. No. 3,264,272. Commercially available ionomer resins include, for example, copolymers of ethylene and methacrylic or acrylic acid, neutralized with metal salts. Examples of commercially available ionomer resins include, but are not limited to, SURLYN® from DuPont de Nemours and Company, and ESCOR® and IOTEK® from Exxon Corporation. These ionomer resins are distinguished by the type of metal ion, the amount of acid, and the degree of neutralization.

U.S. Pat. Nos. 3,454,280, 3,819,768, 4,323,247, 4,526,375, 4,884,814, and 4,911,451 all relate to the use of SURLYN®-type compositions in golf ball covers. However, while SURLYN® covered golf balls, as described in the preceding patents, possess virtually cut-proof covers, the spin and feel are inferior compared to balata covered balls.

Polyurethanes have also been recognized as useful materials for golf ball covers since about 1960 because the resulting golf balls are durable, while at the same time maintaining the “feel” of a balata ball. U.S. Pat. No. 5,334,673 discloses the use of two categories of polyurethane available on the market, i.e., thermoset and thermoplastic polyurethanes, for forming golf ball covers and, in particular, thermoset polyurethane covered golf balls made from a composition of polyurethane prepolymer and a slow-reacting amine curing agent, and/or a glycol. Golf ball covers made from polyurethane have not, to date, fully matched SURLYN® golf balls with respect to resilience or the rebound of the golf ball cover. In addition, when the polyurethane contains aromatic components, yellowing occurs after a short time.

Polyureas have also been proposed as cover materials for golf balls. For instance, U.S. Pat. No. 5,484,870 discloses a polyurea composition comprising the reaction product of an organic isocyanate and an organic amine, each having at least two functional groups. Once these two ingredients are combined, the polyurea is formed, and thus the ability to vary the physical properties of the composition is limited. Like polyurethanes, polyureas are not completely comparable to SURLYN® golf balls with respect to resilience or the rebound or damping behavior of the golf ball cover. And, similar to polyurethanes, the presence of aromatic components in the composition result in yellowing over time.

Therefore, there remains a continuing need for compositions for golf equipment that have excellent light stability, good durability, and a soft “feel.” In particular, it would be advantageous to provide a composition that combines the beneficial properties of aromatic polyurethanes and polyureas, but compensates for the poor light stability due to the carbon-carbon double bonds. The present invention is directed to such a composition.

### SUMMARY OF THE INVENTION

The present invention is directed to a golf ball including a core and a cover, wherein at least a portion of the golf ball is formed from a composition including: a diisocyanate having the general formula: 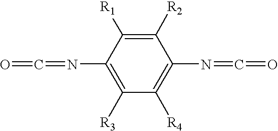
where R₁, R₂, R₃, and R₄ are independently any straight or branched hydrocarbon moiety, acyclic group, cyclic group, heterocyclic group, aromatic group, phenyl group, hydrocarbylene group, or mixtures thereof; a polyol or amine-terminated compound; and a curative blend. In one embodiment, the composition has a difference in yellowness index of about 25 or less after 8 days of ultraviolet exposure.

The diisocyanate may be 2,3,5,6-tetramethyl-1,4-diisocyanatobenzene. In addition, the polyol and amine-terminated compounds may be unsaturated or saturated or, in the alternative, one of the polyol or amine-terminated compound can be unsaturated and the other saturated. The curative blend may also be saturated.

The present invention is also directed to a golf ball including a core and a cover, wherein the cover is formed from a composition including: a diisocyanate having the structure 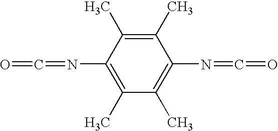
a polyol or amine-terminated compound; and a curing agent. In one embodiment, the curing agent is an amine-terminated curing agent. In another embodiment, the composition includes an amine-terminated compound and is substantially free of urethane linkages. In yet another embodiment, the curing agent is a hydroxy-terminated curing agent, and the composition is substantially free of urea linkages. In still another embodiment, the composition includes urethane and urea linkages.

The present invention also related to a golf ball including: a core; an intermediate layer disposed about the core to form an inner ball; and a cover, wherein the cover includes a composition formed from a prepolymer and a curing agent, wherein the prepolymer is the reaction product of a durene diisocyanate and a polyol or amine-terminated compound, and the curing agent is a hydroxy-terminated curing agent or an amine-terminated curing agent.

The prepolymer may be the reaction product of a durene diisocyanate and an amine-terminated compound. In one embodiment, the amine-terminated compound is selected from the group consisting of amine-terminated hydrocarbons, amine-terminated polyethers, amine-terminated polyesters, amine-terminated polycaprolactones, amine-terminated polycarbonates, amine-terminated polyamides, and mixtures thereof.

While any construction is suitable for use with the present invention, in one embodiment, the cover has a thickness of about 0.02 inches to about 0.035 inches. In addition, the intermediate layer may have a first Shore D hardness and the cover has a second Shore D hardness, and wherein the ratio of second Shore D hardness to the first Shore D hardness is about 0.7 or less. In another embodiment, the core has a diameter of about 1.55 or greater.

In this aspect of the invention, the intermediate layer may include at least one thermoplastic ionomeric material. In one embodiment, the inner ball further includes a moisture barrier layer. In another embodiment, the inner ball is surface treated. In yet another embodiment, the cover has a difference in yellowness index of about 25 or less after 8 days of ultraviolet exposure.

### DETAILED DESCRIPTION OF THE INVENTION

The present invention contemplates polyurethane-based and polyurea-based compositions for golf equipment that include isocyanates having an aromatic component, but the isocyanate groups are not conjugated with the aromatic ring and instead are attached to aliphatic side chains. In particular, suitable isocyanates include durene isocyanates, tertiary isocyanates, and mixtures thereof. For example, in one aspect the invention is directed to a polyurethane composition that includes a prepolymer formed from a durene isocyanate and a polyol, which is cured with a hydroxy-terminated curing agent. In another aspect of the invention, the composition includes urea linkages as a result of a prepolymer, which is formed from a durene isocyanate and an amine-terminated compound, cured with an amine-terminated curing agent. In yet another aspect of the invention, the composition may be either polyurethane-based or polyurea-based and include a tertiary isocyanate in the prepolymer.

The compositions of the invention may also be hybrid polyurethane and polyurea compositions, i.e., include both urethane and urea linkages. For example, the composition may include a polyurethane prepolymer cured with an amine-terminated compound or, in the alternative, a polyurea prepolymer cured with a hydroxy-terminated compound.

The compositions of the invention have improved light stability over their aromatic counterparts. As such, the compositions of the invention may be particularly useful in forming golf ball covers that have been previously formed of aromatic polyurethane or polyurea compositions. Furthermore, a variety of other golf equipment and portions thereof, such as golf club head inserts, golf shoes, or the like, may be formed and/or coated using the compositions of the invention.

Compositions of the Invention

The compositions of the invention can be polyurethane-based, i.e., based on a prepolymer formed from the reaction of an isocyanate and a polyol, which is cured with a hydroxy-terminated curing agent. In addition, the present invention contemplates compositions formed from a polyurea prepolymer, i.e., a prepolymer formed from the reaction product of an isocyanate and an amine-terminated compound, which is cured with an amine-terminated curing agent.

Furthermore, the compositions of the invention may be hybrid polyurethane and polyurea compositions. It should be noted that these hybrid compositions are distinctly different from the “pure” polyurethane and polyurea compositions. For example, the prepolymer may be the reaction product of an isocyanate and a polyol, but cured with an amine-terminated curing agent. The isocyanate groups in the prepolymer react with the hydroxy groups to form urethane linkages and the excess isocyanate in the prepolymer reacts with the amino groups in the curing agent to form urea linkages. For the purposes of the present application, such a composition will be referred to as a polyurethane-urea composition. Conversely, the prepolymer may the reaction product of an isocyanate and an amine-terminated compound, but cured with a polyol. The isocyanate groups in the prepolymer react with the amino groups to form urea linkages and the excess isocyanate in the prepolymer reacts with the hydroxy groups in the curing agent to form urethane linkages. For the purposes of the present application, this type of composition will be referred to as a polyurea-urethane composition. Each component of the compositions of the invention will be discussed in greater detail below.

Isocyanates

As known to those of ordinary skill in the art, the isocyanate groups (NCO) in conventional aromatic isocyanates are attached directly an aromatic ring. As such, extended conjugated double bonds tend to form and cause yellowing of the material. Ultraviolet degradation is believed to occur through oxidation at the carbon attached to the nitrogen, as shown below in the structures of aromatic isocyanates toluene diisocyanate (TDI) and diphenylmethane diisocyanate (MDI).

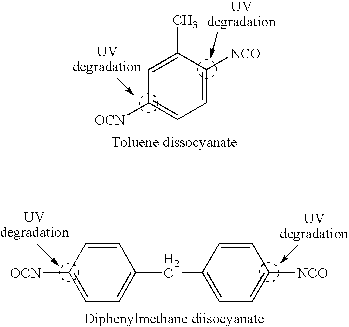

Because of the poor light stability of aromatic isocyanates, manufacturers have started to use aliphatic isocyanates. Skilled artisans are aware, however, that aliphatic isocyanates are less reactive than aromatic isocyanates as reactivity is directly affected by substituents that improve the positive load on the NCO group carbon atom. In addition, reactivity is affected by steric hindrance in isocyanate groups and, thus, bulky substituents near the reaction site reduce the reactivity.

As such, the present invention uses unique isocyanates that function as an aliphatic isocyanate in terms of reactivity and light stability, but contain an aromatic component. The isocyanates suitable for use with the present invention are separated into two groups. The first type of suitable isocyanates contain an aromatic ring and at least two isocyanate groups, but, unlike conventional aromatic isocyanates, the isocyanate groups are attached to aliphatic side chains and not conjugated with the aromatic ring. A general structure is shown below: 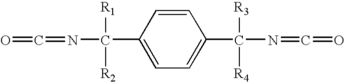
where R₁, R₂, R₃, and R₄ can be any straight or branched hydrocarbon moiety, acyclic group, cyclic group, heterocyclic group, aromatic group, phenyl group, hydrocarbylene group, or a mixture thereof. The isocyanate groups are attached to the aliphatic side chains of the xylene instead of directly to the benzene ring. Because of this arrangement, there are no hydrogens at the site of ultraviolet degradation (as shown below) and, thus, the degradation or discoloration is decreased over that of a conventional aromatic isocyanate.

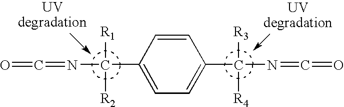

In particular, a suitable isocyanate according to the invention is meta-tetramethylxylene:

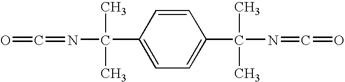

The second type of isocyanates for use in the present invention include isocyanates that have an aromatic ring, but flanking moieties that rotate the nitrogen atom in the isocyanate groups out of plane. This rotation reduces the long wavelength ultraviolet absorbance so that the isocyanate is more stable (as compared to a conventional isocyanate) in terms of chain degradation. A general structure of this type of isocyanate is shown below: 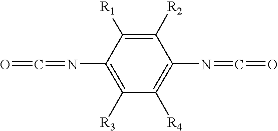
where R₁, R₂, R₃, and R₄ can be any straight or branched hydrocarbon moiety, acyclic group, cyclic group, heterocyclic group, aromatic group, phenyl group, hydrocarbylene group, or a mixture thereof. In one embodiment, R₁, R₂, R₃, and R₄ are the same. In another embodiment, R₁, R₂, R₃, and R₄ are different from each other. A nonlimiting example of this type of isocyanate is 2,3,5,6-tetramethyl-1,4-diisocyanatobenzene (durene isocyanate), which has the following structure:

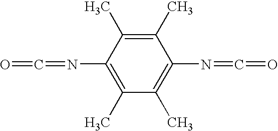

Any suitable method may be used to prepare the isocyanates in this second group, i.e., isocyanates that have an aromatic ring, but flanking moieties that rotate the nitrogen atom in the isocyanate groups out of plane. For example, one suitable method of preparing durene isocyanate is disclosed in British Patent No. 779,806, the entire disclosure of which is incorporated by reference herein. In particular, durene diamine is dissolved in chlorobenzene and then reacted with gaseous hydrogen chloride to form durene diamine dihydrochloride, which is further reacted as a suspension in chlorobenzene with phosgene at an elevated temperature.

Another suitable method of preparation of a durene isocyanate is provided in U.S. Pat. No. 6,486,346, the entire disclosure of which is incorporated by reference herein. In particular, durene is reacted with nitric acid in sulfuric acid, after which the dinitrodurene formed is subjected to catalytic hydrogenation and the resultant durene diamine is subjected to phosgenation. Those of ordinary skill in the art will likely be aware of other methods to form a durene isocyanate for use with the present invention.

Conventional isocyanates may be mixed with any of the isocyanates listed above for the purposes of this invention. For example, a durene isocyanate may be mixed with an aliphatic (saturated) isocyanate, cycloaliphatic isocyanate, aromatic (unsaturated) isocyanate, or any derivatives thereof. The term “saturated,” as used herein, refers to compositions having saturated aliphatic and alicyclic polymer backbones, i.e., with no carbon-carbon double bonds. Nonlimiting examples include substituted and isomeric mixtures including 2,2′-, 2,4′-, and 4,4′-diphenylmethane diisocyanate (MDI); 3,3′-dimethyl-4,4′-biphenylene diisocyanate (TODI); toluene diisocyanate (TDI); polymeric MDI; carbodiimide-modified liquid 4,4′-diphenylmethane diisocyanate; para-phenylene diisocyanate (PPDI); meta-phenylene diisocyanate (MPDI); triphenyl methane-4,4′- and triphenyl methane-4,4″-triisocyanate; naphthylene-1,5-diisocyanate; 2,4′-, 4,4′-, and 2,2-biphenyl diisocyanate; polyphenylene polymethylene polyisocyanate (PMDI) (also known as polymeric PMDI); mixtures of MDI and PMDI; mixtures of PMDI and TDI; ethylene diisocyanate; propylene-1,2-diisocyanate; tetramethylene-1,2-diisocyanate; tetramethylene-1,3-diisocyanate; tetramethylene-1,4-diisocyanate; 1,6-hexamethylene diisocyanate (HDI); octamethylene diisocyanate; decamethylene diisocyanate; 2,2,4-trimethylhexamethylene diisocyanate; 2,4,4-trimethylhexamethylene diisocyanate; dodecane-1,12-diisocyanate; dicyclohexylmethane diisocyanate; cyclobutane-1,3-diisocyanate; cyclohexane-1,2-diisocyanate; cyclohexane-1,3-diisocyanate; cyclohexane-1,4-diisocyanate; methylcyclohexylene diisocyanate (HTDI); 2,4-methylcyclohexane diisocyanate; 2,6-methylcyclohexane diisocyanate; 4,4′-dicyclohexyl diisocyanate; 2,4′-dicyclohexyl diisocyanate; 1,3,5-cyclohexane triisocyanate; isocyanatomethylcyclohexane isocyanate; 1-isocyanato-3,3,5-trimethyl-5-isocyanatomethylcyclohexane; isocyanatoethylcyclohexane isocyanate; bis(isocyanatomethyl)-cyclohexane diisocyanate; 4,4′-bis(isocyanatomethyl)dicyclohexane; 2,4′-bis(isocyanatomethyl)dicyclohexane; isophorone diisocyanate (IPDI); triisocyanate of HDI; triisocyanate of 2,2,4-trimethyl-1,6-hexane diisocyanate (TMDI); 4,4′-dicyclohexylmethane diisocyanate (H₁₂MDI); 2,4-hexahydrotoluene diisocyanate; 2,6-hexahydrotoluene diisocyanate; 1,2-, 1,3-, and 1,4-phenylene diisocyanate; aromatic aliphatic isocyanate, such as 1,2-, 1,3-, and 1,4-xylene diisocyanate; meta-tetramethylxylene diisocyanate (m-TMXDI); para-tetramethylxylene diisocyanate (p-TMXDI); trimerized isocyanurate of any polyisocyanate, such as isocyanurate of toluene diisocyanate, trimer of diphenylmethane diisocyanate, trimer of tetramethylxylene diisocyanate, isocyanurate of hexamethylene diisocyanate, and mixtures thereof; dimerized uretdione of any polyisocyanate, such as uretdione of toluene diisocyanate, uretdione of hexamethylene diisocyanate, and mixtures thereof; modified polyisocyanate derived from the above isocyanates and polyisocyanates; and mixtures thereof.

Polyols/Amine-Terminated Compounds

The polyurethane-based and polyurea-based compositions of the present invention may be formed by first forming a prepolymer and then curing the prepolymer with a curing agent. Prepolymers are formed by reacting the isocyanates discussed above with a polyol or an amine-terminated compound, depending on the desired linkages. For example, a polyurethane prepolymer is formed by reacting an isocyanate and a polyol, whereas a polyurea prepolymer is formed by reacting an isocyanate and an amine-terminated compound. While the polyols and amine-terminated compounds in this section are discussed in terms of the prepolymer technique, those of ordinary skill in the art will appreciate that any of the polyols or amine-terminated compounds discussed in this section may also be used with a one-shot technique (discussed in greater detail below).

Any polyol available to one of ordinary skill in the art is suitable for use in the polyurethane prepolymer. Exemplary polyols include, but are not limited to, polyether polyols, polycaprolactone polyols, polyester polyols, polycarbonate polyols, hydrocarbon polyols, and mixtures thereof. Because the isocyanates of the invention confer greater light stability to the compositions of the invention, the polyol may or may not be aliphatic (saturated). If the polyol is not saturated, however, the cured composition preferably includes a light stabilizer.

Suitable polyether polyols for use in the present invention include, but are not limited to, polytetramethylene ether glycol (PTMEG); copolymer of polytetramethylene ether glycol and 2-methyl-1,4-butane diol (PTG-L); poly(oxyethylene) glycol; poly(oxypropylene) glycol; ethylene oxide capped (polyoxypropylene) glycol; poly(oxypropylene oxyethylene) glycol; and mixtures thereof.

Suitable polycaprolactone polyols include, but not limited to, diethylene glycol initiated polycaprolactone; propylene glycol initiated polycaprolactone; 1,4-butanediol initiated polycaprolactone; trimethylol propane initiated polycaprolactone; neopentyl glycol initiated polycaprolactone; 1,6-hexanediol initiated polycaprolactone; polytetramethylene ether glycol (PTMEG) initiated polycaprolactone; ethylene glycol initiated polycaprolactone; dipropylene glycol initiated polycaprolactone; and mixtures thereof.

Suitable polyester polyols include, but not limited to, polyethylene adipate glycol; polyethylene propylene adipate glycol; polybutylene adipate glycol; polyethylene butylene adipate glycol; polyhexamethylene adipate glycol; polyhexamethylene butylene adipate glycol; ortho-phthalate-1,6-hexanediol polyester polyol; polyethylene terephthalate polyester polyols; and mixtures thereof.

Examples of polycarbonate polyols that may be used with the present invention include, but is not limited to, poly(phthalate carbonate) glycol, poly(hexamethylene carbonate) glycol, polycarbonate polyols containing bisphenol A, and mixtures thereof.

Hydrocarbon polyols include, but not limited to, hydroxy-terminated liquid isoprene rubber (LIR), hydroxy-terminated polybutadiene polyol, hydroxy-terminated polyolefin polyols, hydroxy-terminated hydrocarbon polyols, and mixtures thereof.

Other polyols that may be used to form the prepolymer of the invention include, but not limited to, glycerols; castor oil and its derivatives; Polytail H; Polytail HA; Kraton polyols; acrylic polyols; acid functionalized polyols based on a carboxylic, sulfonic, or phosphoric acid group; dimer alcohols converted from the saturated dimerized fatty acid; and mixtures thereof.

By using polyols based on a hydrophobic backbone, the polyurethane compositions of the invention may be more water resistant than those polyurethane compositions having polyols without a hydrophobic backbone. Some non-limiting examples of polyols based on a hydrophobic backbone include hydrocarbon polyols, hydroxy-terminated polybutadiene polyols, polyethers, polycaprolactones, and polyesters.

In one embodiment, the polyol has an average molecular weight of about 500 to about 6000 and a functionality of at least 2. In another embodiment, the average molecular weight of the polyol is about 800 to about 4,000. In still another embodiment, the polyol has an average molecular weight of about 1,000 to about 3,500.

Any amine-terminated compound available to one of ordinary skill in the art is suitable for use in the polyurea prepolymer. The amine-terminated compound may include amine-terminated hydrocarbons, amine-terminated polyethers, amine-terminated polyesters, amine-terminated polycarbonates, amine-terminated polycaprolactones, and mixtures thereof. The amine-terminated segments may be in the form of a primary amine (NH₂) or a secondary amine (NHR). Any of the amine-terminated components discussed below with respect to the curing agent may also be used to form the polyurea prepolymer. And, as with the polyol component, the amine-terminated compound may be saturated or unsaturated. In one embodiment, the amine-terminated is saturated.

The molecular weight of the amine-terminated compound for use in the invention may range from about 100 to about 10,000. In one embodiment, the amine-terminated compound is about 500 or greater, preferably about 1000 or greater, and even more preferably about 2000 or greater. In another embodiment, the amine-terminated compound molecular weight is about 8000 or less, preferably about 4,000 or less, and more preferably about 3,000 or less. For example, in one embodiment, the molecular weight of the amine-terminated compound is about 1000 to about 4000. Because lower molecular weight polyether amines may be prone to forming solid polyureas, a higher molecular weight oligomer may be used to avoid solid formation.

In one embodiment, the amine-terminated compound includes amine-terminated hydrocarbons having the following generic structures: 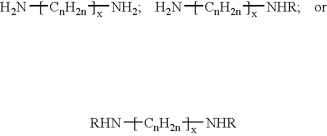
where x is the chain length, i.e., 1 or greater, n is preferably about 1 to about 12, and R is any alkyl group having from about 1 to about 20 carbon atoms, preferably about 1 to about 12 carbon atoms, a phenyl group, a cyclic group, or mixture thereof.

The amine-terminated compound may also include any of the amine-terminated polyethers discussed above with respect to the polyamine used to make the polyamine adduct for the curing agent/chain extender. Due to the rapid reaction of isocyanate and amine, and the insolubility of many urea products, however, the selection of diamines and polyether amines is limited to those allowing the successful formation of the polyurea prepolymers. In addition, because lower molecular weight polyether amines may be prone to forming solid polyureas during prepolymer preparation, a higher molecular weight oligomer, such as Jeffamine® D2000, is preferred.

In addition, the amine-terminated compound may include amine-terminated polyesters having the generic structures: 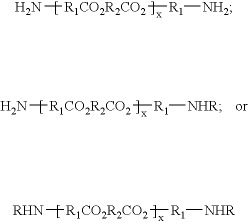
where x is the chain length, i.e., 1 or greater, preferably about 1 to about 20, R is any alkyl group having from about 1 to about 20 carbon atoms, preferably about 1 to about 12 carbon atoms, a phenyl group, a cyclic group, or mixture thereof, and R₁ and R₂ are straight or branched hydrocarbon chains, e.g., alkyl or aryl chains.

Copolymers of polycaprolactone and polyamines may also be used to form the polyurea prepolymers of the present invention. These copolymers include, but are not limited to, bis(2-aminoethyl)ether initiated polycaprolactone, 2-(2-aminoethylamino)ethanol, 2-2(aminoethylamino)ethanol, polyoxyethylene diamine initiated polycaprolactone, propylene diamine initiated polycaprolactone, polyoxypropylene diamine initiated polycaprolactone, 1,4-butanediamine initiated polycaprolactone, trimethylolpropane-based triamine initiated polycaprolactone, neopentyl diamine initiated polycaprolactone, hexanediamine initiated polycaprolactone, polytetramethylene ether diamine initiated polycaprolactone, and mixtures thereof. In addition, polycaprolactone polyamines having the following structures may be useful in forming the polyurea prepolymers of the present invention: 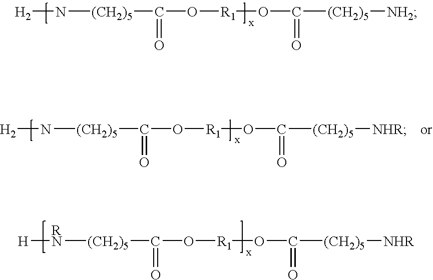
where x is the chain length, i.e., 1 or greater, preferably about 1 to about 20, R is one of an alkyl group having from about 1 to about 20 carbons, preferably about 1 to about 12 carbons, a phenyl group, or a cyclic group, and R₁ is a straight or branched hydrocarbon chain including about 1 to about 20 carbons.

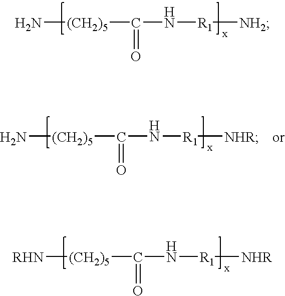

where x is the chain length, i.e., 1 or greater, preferably about 1 to about 20, R is one of an alkyl group having from about 1 to about 20 carbons, preferably about 1 to about 12 carbons, a phenyl group, or a cyclic group, and R₁ is a straight or branched hydrocarbon chain including about 1 to about 20 carbons.

In another embodiment, the amine-terminated compound may be an amine-terminated polycarbonate having one of the following generic structures: 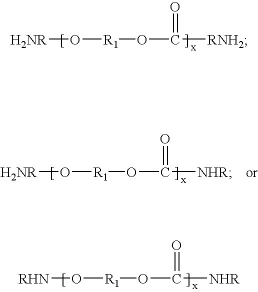
where x is the chain length, which preferably ranges from about 1 to about 20, R is one of an alkyl group having from about 1 to about 20 carbons, preferably about 1 to about 12 carbons, a phenyl group, or a cyclic group, and R₁ is a straight chain hydrocarbon or predominantly bisphenol A units or derivatives thereof.

Amine-terminated polyamides may also be reacted with the isocyanate component to form the polyurea prepolymer component of the present invention. Suitable amine-terminated polyamides include, but are not limited to, those having following structures: 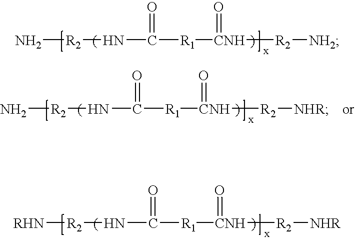
where x is the chain length, i.e., about 1 or greater, R is one of an alkyl group having from about 1 to about 20 carbons, preferably about 1 to about 12 carbons, a phenyl group, or a cyclic group, R₁ is an alkyl group having about 1 to about 12 carbon atoms, a phenyl group, or a cyclic group, and R₂ is an alkyl group having about 1 to about 12 carbon atoms (straight or branched), a phenyl group, or a cyclic group.

Additional amine-terminated compounds may also be useful in forming the polyurea prepolymers of the present invention include, but are not limited to, poly(acrylonitrile-co-butadiene); poly(1,4-butanediol) bis(4-aminobenzoate) in liquid or waxy solid form; linear and branched polyethylenimine; low and high molecular weight polyethylenimine having an average molecular weight of about 500 to about 30,000; poly(propylene glycol) bis(2-aminopropyl ether) having an average molecular weight of about 200 to about 5,000; polytetrahydrofuran bis(3-aminopropyl) terminated having an average molecular weight of about 200 to about 2000; and mixtures thereof, all of which are available from Aldrich of Milwaukee, Wis.

Thus, in one embodiment, the polyurea prepolymer includes a poly(acrylonitrile-co-butadiene) having one of the following structures: 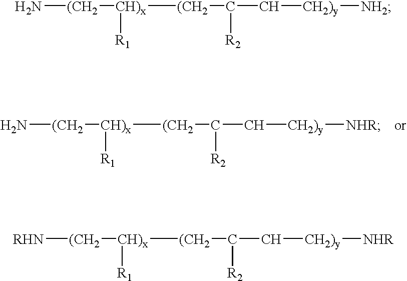
wherein x and y are chain lengths, i.e., greater than about 1, R is any alkyl group having from about 1 to about 20 carbon atoms, preferably about 1 to about 12 carbon atoms, a phenyl group, a cyclic group, or mixture thereof, R₁ is a hydrogen, methyl group, cyano group, phenyl group, or a mixture thereof, and R₂ is a hydrogen, a methyl group, chloride, or a mixture thereof. In one embodiment, the y:x ratio is about 82:18 to about 90:10. In other words, the poly(acrylonitrile-co-butadiene) may have from about 10 percent to about 18 percent acrylonitrile by weight.

In another embodiment, the polyurea prepolymer includes a poly(1,4-butanediol) bis(4-aminobenzoate) having one of the following structures: 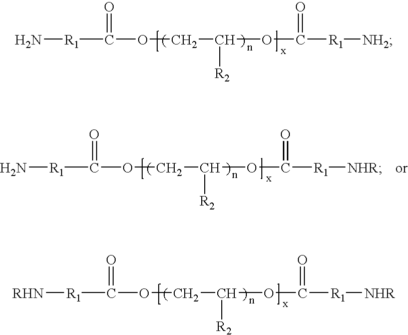
where x and n are chain lengths, i.e., 1 or greater, and n is preferably about 1 to about 12, R and R₁ are linear or branched hydrocarbon chains, an alkyl group having from about 1 to about 20 carbons, preferably about 1 to about 12 carbons, a phenyl group, a cyclic group, or mixtures thereof, and R₂ is a hydrogen, a methyl group, or a mixture thereof. In one embodiment, R₁ is phenyl, R₂ is hydrogen, and n is about 2.

In yet another embodiment, the polyurea prepolymer includes at least one linear or branched polyethyleneimine having one of the following structures: 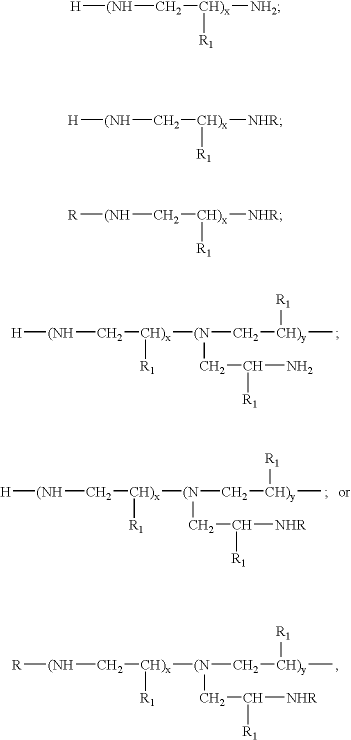
wherein x and y are chain lengths, i.e., greater than about 1, R is any alkyl group having from about 1 to about 20 carbon atoms, preferably about 1 to about 12 carbon atoms, a phenyl group, a cyclic group, or mixture thereof, and R₁ is a hydrogen, methyl group, or a mixture thereof. In one embodiment, R₁ is hydrogen. In another embodiment, the polyurea prepolymer includes a mixture of linear and branched polyethyleneimines.

In still another embodiment, the polyurea prepolymer of the present invention includes a polytetrahydrofuran bis(3-aminopropyl) terminated compound having one of the following structures: 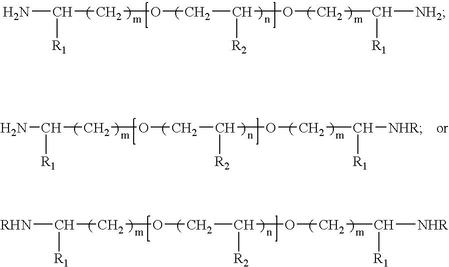
where m and n are chain lengths, i.e., 1 or greater, n is preferably about 1 to about 12 and m is preferably about 1 to about 6, R is any one alkyl group having from about 1 to about 20 carbons, preferably about 1 to about 12 carbons, a phenyl group, a cyclic group, or mixtures thereof, and R₁ and R₂ are hydrogen, methyl groups, or mixtures thereof. In one embodiment, both R₁ and R₂ are hydrogen and both m and n are about 2.

In addition, diamines and triamines may be used with the isocyanate to form the polyurea prepolymer of the present invention. In one embodiment, aromatic diamines may be used when an ultraviolet stabilizer or whitening agent is intended to be incorporated during post processing. U.S. Pat. No. 5,484,870 provides suitable aromatic diamines suitable for use with the present invention, the entire disclosure of which is incorporated by reference herein. For example, useful aromatic polyamines include polymethylene-di-p-aminobenzoates, polyethyleneglycol-bis(4-aminobenzoate), polytetramethylene etherglycol-di-p-aminobenzoate, polypropyleneglycol-di-p-aminobenzoate, and mixtures thereof. In addition, triamines that may be used in forming the prepolymer of the invention include N,N,N′,N′-tetramethyl-ethylenediamine, 1,4-diazobicyclo(2,2,2)-octane, N-methyl-N′-dimethylaminoethylpiperazine, N,N-dimethylbenzylamine, bis-(N,N-diethylaminoethyl)-adipate, N,N-diethylbenzylamine, pentamethyldiethylenetriamine, N,N-dimethylclyclohexylamine, N,N,N′,N′-tetramethyl-1,3-butanediamine, N,N-dimethyl-beta-phenylethylamine, 1,2-dimethylimidazole, and 2-methylimidazole.

By using an amine-terminated component based on a hydrophobic segment, the polyurea-based compositions of the invention may be more water resistant than those polyurea compositions formed with an amine-terminated hydrophilic segment. Thus, in one embodiment, the amine-terminated compound includes hydrophobic backbone, e.g., an unsaturated or saturated hydrocarbon-based amine-terminated compound. One example of an amine-terminated hydrocarbon is an amine-terminated polybutadiene.

Curatives

A single curing agent or a blend of curing agents is used to cure the composition. The curing agent of the invention may be a hydroxy-terminated curing agent, an amine-terminated curing agent, or a mixture thereof. The hydroxy-terminated and amine-terminated curing agents may include one or more saturated, unsaturated, aromatic, and cyclic groups. Additionally, the hydroxy-terminated and amine curatives may include one or more halogen groups.

As briefly mentioned above, however, the selection of curing agent is critical in determining whether the composition of the invention is “pure” polyurethane, “pure” polyurea, or a hybrid, i.e., polyurethane/urea or polyurea/urethane. For the purposes of the present application, a polyurethane composition contains urethane linkages having the following general structure: 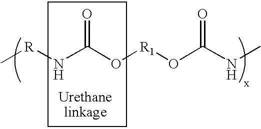
where x is the chain length, i.e., about 1 or greater, and R and R₁ are straight chain or branched hydrocarbon chain having about 1 to about 20 carbons. The composition is substantially free of urea linkages. “Substantially free” as used herein refers to compositions having less than 5 percent, preferably less than 1 percent, and more preferably less than 0.5 percent of the specified linkage. Thus, a polyurethane composition is formed by reacting an isocyanate and a polyol to form a prepolymer, and then curing the prepolymer with a hydroxy-terminated curing agent. The excess isocyanate groups in the prepolymer reacts with the hydroxyl groups to form additional urethane linkages.

On the other hand, a polyurea composition is substantially free of urethane linkages. In other words, a polyurea composition contains only urea linkages having the following general structure: 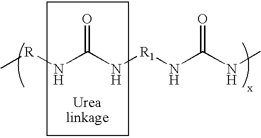
where x is the chain length, i.e., about 1 or greater, and R and R₁ are straight chain or branched hydrocarbon chain having about 1 to about 20 carbons. A pure polyurea composition is the result of a polyurea prepolymer cured with an amine-terminated curing agent. As such, the excess isocyanate groups in the prepolymer react with the amino groups to form additional urea linkages.

Alternatively, hybrid polyurethane and polyurea compositions, i.e., polyurethane-ureas and polyurea-urethanes, contains both urea and urethane linkages as a result of using an amine-terminated curing agent (or a curative blend including amino groups) with a polyurethane prepolymer or a hydroxy-terminated curing agent (or a curative blend including hydroxyl groups) with a polyurea prepolymer.

Suitable hydroxy-terminated curing agents include, but are not limited to, ethylene glycol; diethylene glycol; polyethylene glycol; propylene glycol; 2-methyl-1,3-propanediol; 2,-methyl-1,4-butanediol; dipropylene glycol; polypropylene glycol; 1,2-butanediol; 1,3-butanediol; 1,4-butanediol; 2,3-butanediol; 2,3-dimethyl-2,3-butanediol; trimethylolpropane; cyclohexyldimethylol; triisopropanolamine; N,N,N′N′-tetra-(2-hydroxypropyl)-ethylene diamine; diethylene glycol bis-(aminopropyl)ether; 1,5-pentanediol; 1,6-hexanediol; 1,3-bis-(2-hydroxyethoxy)cyclohexane; 1,4-cyclohexyldimethylol; 1,3-bis-[2-(2-hydroxyethoxy)ethoxy]cyclohexane; 1,3-bis-{2-[2-(2-hydroxyethoxy)ethoxy]ethoxy}cyclohexane; polytetramethylene ether glycol (PTMEG); resorcinol-di-(beta-hydroxyethyl)ether and its derivatives; hydroquinone-di-(beta-hydroxyethyl)ether and its derivatives; 1,3-bis-(2-hydroxyethoxy)benzene; 1,3-bis-[2-(2-hydroxyethoxy)ethoxy]benzene; 1,3-bis-{2-[2-(2-hydroxyethoxy)ethoxy]ethoxy}benzene; N,N-bis(β-hydroxypropyl)aniline; 2-propanol-1,1′-phenylaminobis; 1,1,1-tris(hydroxymethyl)-n-propane; and mixtures thereof.

The hydroxy-terminated curing agent may have a molecular weight of at least about 50. In one embodiment, the molecular weight of the hydroxy-terminated curing agent is about 2000 or less. In yet another embodiment, the hydroxy-terminated curing agent has a molecular weight of about 250 to about 3900. For example, in one embodiment, the hydroxyl-terminated curing agent is PTMEG, which has a molecular weight of about 250 to about 3900. It should be understood that molecular weight, as used herein, is the absolute weight average molecular weight and would be understood as such by one of ordinary skill in the art.

In another aspect, the hydroxy-terminated curing agent has a molecular weight of about 18 to about 800, preferably less than 400, and more preferably from about 60 to about 300. The functionality of the hydroxy-terminated curing agents for use with the present invention is preferably greater than 2, more preferably from about 3 to about 6.

Because an objective of the present invention is improved light stability, the hydroxyl-terminated curing agent is preferably aliphatic (or saturated). Suitable saturated hydroxy-terminated curing agents include, but are not limited to, ethylene glycol; diethylene glycol; polyethylene glycol; propylene glycol; 2-methyl-1,3-propanediol; 2,-methyl-1,4-butanediol; dipropylene glycol; polypropylene glycol; 1,2-butanediol; 1,3-butanediol; 1,4-butanediol; 2,3-butanediol; 2,3-dimethyl-2,3-butanediol; trimethylolpropane; cyclohexyldimethylol; triisopropanolamine; N,N,N′,N′-tetra-(2-hydroxypropyl)-ethylene diamine; diethylene glycol bis-(aminopropyl)ether; 1,5-pentanediol; 1,6-hexanediol; 1,3-bis-(2-hydroxyethoxy)cyclohexane; 1,4-cyclohexyldimethylol; 1,3-bis-[2-(2-hydroxyethoxy)ethoxy]cyclohexane; 1,3-bis-{2-[2-(2-hydroxyethoxy)ethoxy]ethoxy}cyclohexane; polytetramethylene ether glycol having molecular weight ranging from about 250 to about 3900; and mixtures thereof.

Suitable amine-terminated curing agents include, but are not limited to, ethylene diamine; hexamethylene diamine; 1-methyl-2,6-cyclohexyl diamine; 2,2,4- and 2,4,4-trimethyl-1,6-hexanediamine; 4,4′-bis-(sec-butylamino)-dicyclohexylmethane and derivatives thereof; 1,4-bis-(sec-butylamino)-cyclohexane; 1,2-bis-(sec-butylamino)-cyclohexane; 4,4′-dicyclohexylmethane diamine; 1,4-cyclohexane-bis-(methylamine); 1,3-cyclohexane-bis-(methylamine), isomers, and mixtures thereof; diethylene glycol bis-(aminopropyl)ether; 2-methylpentamethylene-diamine; diaminocyclohexane, isomers, and mixtures thereof; diethylene triamine; triethylene tetramine; tetraethylene pentamine; propylene diamine; 1,3-diaminopropane; dimethylamino propylamine; diethylamino propylamine; imido-bis-(propylamine); monoethanolamine, diethanolamine; triethanolamine; monoisopropanolamine, diisopropanolamine; isophoronediamine; 4,4′-methylenebis-(2-chloroaniline); 3,5-dimethylthio-2,4-toluenediamine; 3,5-dimethylthio-2,6-toluenediamine; 3,5-diethylthio-2,4-toluenediamine; 3,5-diethylthio-2,6-toluenediamine; 4,4′-bis-(sec-butylamino)-diphenylmethane and derivatives thereof; 1,4-bis-(sec-butylamino)-benzene; 1,2-bis-(sec-butylamino)-benzene; N,N′-dialkylamino-diphenylmethane; trimethyleneglycol-di-p-aminobenzoate; polytetramethyleneoxide-di-p-aminobenzoate; 4,4′-methylenebis-(3-chloro-2,6-diethyleneaniline); 4,4′-methylenebis-(2,6-diethylaniline); meta-phenylenediamine; paraphenylenediamine; N,N′-diisopropyl-isophoronediamine; polyoxypropylene diamine; propylene oxide-based triamine; 3,3′-dimethyl-4,4′-diaminocyclohexylmethane; and mixtures thereof. In addition, any of the amine-terminated moieties listed below with respect to the prepolymer may be used as curing agents according to the invention.

The molecular weight of the amine-terminated curing agent is preferably about 64 or greater. In one embodiment, the molecular weight of the amine-curing agent is about 2000 or less. In another embodiment, the amine-terminated curing agent has a molecular weight of about 100 to about 1800. In yet another embodiment, the molecular weight of the amine-terminated curing agent is about 150 to about 1700.

As mentioned above, the curing agent is preferably aliphatic (or saturated) in order to confer the greatest degree of light stability. Thus, of the list above, the saturated amine-terminated curing agents suitable for use with the present invention include, but are not limited to, ethylene diamine; hexamethylene diamine; 1-methyl-2,6-cyclohexyl diamine; 2,2,4- and 2,4,4-trimethyl-1,6-hexanediamine; 4,4′-bis-(sec-butylamino)-dicyclohexylmethane; 1,4-bis-(sec-butylamino)-cyclohexane; 1,2-bis-(sec-butylamino)-cyclohexane; derivatives of 4,4′-bis-(sec-butylamino)-dicyclohexylmethane; 4,4′-dicyclohexylmethane diamine; 1,4-cyclohexane-bis-(methylamine); 1,3-cyclohexane-bis-(methylamine); diethylene glycol bis-(aminopropyl)ether; 2-methylpentamethylene-diamine; diaminocyclohexane; diethylene triamine; triethylene tetramine; tetraethylene pentamine; propylene diamine; dipropylene triamine; 1,3-diaminopropane; dimethylamino propylamine; diethylamino propylamine; imido-bis-(propylamine); monoethanolamine, diethanolamine; triethanolamine; monoisopropanolamine, diisopropanolamine; triisopropanolamine; isophoronediamine; N,N′-diisopropylisophorone diamine and mixtures thereof.

It is important to note, however, that many amine-terminated compounds may be unsuitable for reaction with the isocyanate because of the autocatalytic nature and rapid reaction between the two components. For example, unhindered primary diamines are generally fast reacting. In addition, aliphatic amines react more quickly than aromatics of lower basicity, since there is not any significant steric hindrance. In fact, the ortho position substituents of aromatic isocyanates strongly reduce the reactivity. Based on this knowledge, but without being bound to any particular theory, it is believed that an amine with a high level of stearic hindrance, e.g., a tertiary butyl group on the nitrogen atom, has a slower reaction rate than an amine with no hindrance or a low level of hindrance.

Moreover, a hindered secondary diamine may be suitable for use in the prepolymer in order to slow the reaction somewhat. An example of a hindered secondary diamine is 4,4′-bis-(sec-butylamino)-dicyclohexylmethane (Clearlink 1000). In addition, N,N′-diisopropyl-isophorone diamine, available from Huntsman Corporation under the tradename Jefflink, may be used as the secondary diamine curing agent.

To further improve the shear resistance of the resulting polyurethane and polyurea elastomers, a trifunctional curing agent may also be used to help improve crosslinking. In such cases, a triol, such as trimethylolpropane, or a tetraol, such as N,N, N′,N′-tetrakis(2-hydroxylpropyl)ethylenediamine, may be added to the curative blends. Useful triamine curing agents for improving the crosslinking of polyurethane and polyurea elastomers include, but are not limited to: propylene oxide-based triamines; trimethylolpropane-based triamines; glycerin-based triamines; N,N-bis{2-[(aminocarbonyl)amino]ethyl}-urea; N,N′,N″-tris(2-aminoethyl)-methanetriamine; N1-(5-aminopentyl)-1,2,6-hexanetriamine; 1,1,2-ethanetriamine; N,N′,N″-tris(3-aminopropyl)-methanetriamine; N1-(2-aminoethyl)-1,2,6-hexanetriamine; N1-(10-aminodecyl)-1,2,6-hexanetriamine; 1,9,18-octadecanetriamine; 4,10,16,22-tetraazapentacosane-1,δ 3,25-triamine; N1-{3-[[4-[(3-aminopropyl)amino]butyl]amino]propyl}-1,2,6-hexanetriamine; di-9-octadecenyl-(Z,Z)-1,2,3-propanetriamine; 1,4,8-octanetriamine; 1,5,9-nonanetriamine; 1,9,10-octadecanetriamine; 1,4,7-heptanetriamine; 1,5,10-decanetriamine; 1,8,17-heptadecanetriamine; 1,2,4-butanetriamine; propanetriamine; 1,3,5-pentanetriamine; N1-{3-[[4-[(3-aminopropyl)amino]butyl]amino]propyl}-1,2,6-hexanetriamine; N1-{4-[(3-aminopropyl)amino]butyl}-1,2,6-hexanetriamine; 2,5-dimethyl-1,4,7-heptanetriamine; N1-(6-aminohexyl)-1,2,6-hexanetriamine; 6-ethyl-3,9-dimethyl-3,6,9-undecanetriamine; 1,5,11-undecanetriamine; 1,6,11-undecanetriamine; N,N-bis(aminomethyl)-methanediamine; N,N-bis(2-aminoethyl)-1,3-propanediamine; methanetriamine; N1-(2-aminoethyl)-N2-(3-aminopropyl)-1,2,5-pentanetriamine; N1-(2-aminoethyl)-1,2,6-hexanetriamine; 2,6,11-trimethyl-2,6,11-dodecanetriamine; 1,1,3-propanetriamine; 6-(aminomethyl)-1,4,9-nonanetriamine; 1,2,6-hexanetriamine; N2-(2-aminoethyl)-1,1,2-ethanetriamine; 1,3,6-hexanetriamine; N,N-bis(2-aminoethyl)-1,2-ethanediamine; 3-(aminomethyl)-1,2,4-butanetriamine; 1,1,1-ethanetriamine; N1,N1-bis(2-aminoethyl) 1,2-propanediamine; 1,2,3-propanetriamine; 2-methyl-1,2,3-propanetriamine; and mixtures thereof.

In one embodiment, the curing agent is a modified curative blend as disclosed in co-pending U.S. Patent Publication No. 2003/0212240, which is incorporated by reference herein in its entirety. For example, the curing agent of the invention may be modified with a freezing point depressing agent to create a curative blend with a slower onset of solidification and with storage stable pigment dispersion. The freezing point depressing agent is preferably added in an amount sufficient to reduce the freezing point of the curing agent by a suitable amount to prevent loss of pigment dispersion, but not affect the physical properties of the golf ball. Thus, a curative blend according to the present invention may include a polyamine adduct and a freezing point depressing agent.

Processing the Elastomers

As discussed briefly above, there are two basic techniques used to process the elastomers of the invention: the one-shot technique and the prepolymer technique, however, any suitable technique may be used so long as it results in the polyurethane-based or polyurea-based compositions of the invention. For example, the one-shot technique reacts the isocyanate, the polyol or amine-terminated compound, and the curing agent in one step. In contrast, the prepolymer technique requires a first reaction between the polyol or amine-terminated compound and the isocyanate to produce the prepolymer, and a subsequent reaction between the prepolymer and a curing agent. The reactants may be combined at any suitable temperature that allows the reaction to proceed. For example, the temperature may range from about 32° F. to about 180° F. In one embodiment, the reaction temperature is about 75° F. to about 170° F. In another embodiment, the reaction occurs at a temperature of about 75° F. to about 150° F.

Either method may be employed to produce the compositions of the invention, however, the prepolymer technique is generally preferred when using the compositions of the invention for structural layers because it provides better control of chemical reaction and, consequently, results in more uniform properties for the elastomers. U.S. Pat. No. 6,784,219, the entire disclosure of which is incorporated by reference herein, discloses several methods for preparing compositions including durene isocyanates that are suitable for use with the present invention.

The ratio of isocyanate to polyol or amine-terminated compound in the prepolymer is any suitable ratio that eventually results in a polyurethane-based or polyurea-based composition (after being cured with a curing agent) having improved light stability over those compositions including aromatic isocyanates. For example, the isocyanate to polyol/amine ratio in the prepolymer may range from about 1:0.75 to about 1:1.5, on a molar basis. In one embodiment, the isocyanate-polyol/amine ratio is about 1:0.85 to about 1:1.25. In yet another embodiment, the ratio of isocyanate to polyol/amine in the prepolymer is about 1:0.9 to about 1:1.1.

The number of unreacted NCO groups in the prepolymer may be varied to control such factors as the speed of the reaction, the resultant hardness of the composition, and the like. For example, as the weight percent of unreacted isocyanate groups increases, the hardness also increases in a somewhat linear fashion. Thus, when the NCO content is about 10.5 weight percent, the hardness may be less than about 55 Shore A, whereas once the NCO content increases about 15 weight percent, the hardness is greater than about 80 Shore A.

In one embodiment, the number of unreacted NCO groups in the prepolymer of isocyanate and polyether amine is less than about 14 percent. For example, the prepolymer may have from about 5 percent to about 11 percent unreacted NCO groups, and even more preferably have from about 6 to about 9.5 percent unreacted NCO groups. In one embodiment, the percentage of unreacted NCO groups is about 3 percent to about 9 percent. Alternatively, the percentage of unreacted NCO groups may be about 7.5 percent or less, and more preferably, about 7 percent or less. In another embodiment, the unreacted NCO content is from about 2.5 percent to about 7.5 percent, and more preferably from about 4 percent to about 6.5 percent.

In one aspect of the invention, the prepolymer is stripped of the free isocyanate monomer. For example, after stripping, the prepolymer may contain about 1 percent or less free isocyanate monomer. In another embodiment, the prepolymer contains about 0.5 percent by weight or less of free isocyanate monomer.

Depending on the prepolymer to curative ratio, which is a function of the NCO content of the prepolymer and molecular weight of the curing agent, the polyurea-based or polyurethane-based compositions of the invention may be thermoset or thermoplastic in nature. For example, thermoplastic compositions of the invention include linear polymers and are typically formed curing the prepolymer with a diol or secondary diamine, i.e., a diamine having only one available hydrogen such that crosslinking is not possible, with 1:1 stoichiometry in the absence of moisture. Thermoset compositions of the invention, on the other hand, are cross-linked polymers and are typically produced from the reaction of a diisocyanate and a polyol cured with a primary diamine or polyfunctional glycol, e.g., a glycol or amine with more than one hydrogen.

Furthermore, the amounts of reactants may be varied to adjust the mechanical properties of the resultant polyurethane or polyurea. For example, the hardness of the composition is a function of the number of crosslinks. Thus, in one aspect of the invention, the polyol or amine-terminated compound is preferably present in an amount of about 30 to about 95 percent by weight of the reactive components, and more preferably from about 50 to about 90 percent by weight of the reactive components. The isocyanate is preferably present in an amount of about 5 to about 40 percent by weight of the reactive components, and more preferably from about 10 to about 25 percent by weight of the reactive components. The curative may be present in an amount of about 0.5 to 40 percent by weight of the reactive components, preferably about 1 to about 30 percent.

In order to prepare a foamed composition, i.e., a cellular structure, the polyol or amine-terminated compound is preferably present in an amount of about 45 to about 95 percent by weight of the reactive components, and more preferably from about 60 to about 90 percent by weight of the reactive components. The isocyanate is preferably present in an amount of about 5 to about 40 percent by weight of the reactive components, and more preferably from about 10 to about 25 percent by weight of the reactive components. The curative may be present in an amount of about 0.1 to 20 percent by weight of the reactive components, preferably about 0.2 to about 10 percent.

Composition Additives

Additional materials may be added to the compositions of the invention. These additional materials include, but are not limited to, catalysts, wetting agents, coloring agents, optical brighteners, crosslinking agents, whitening agents such as TiO₂ and ZnO, UV absorbers, hindered amine light stabilizers, defoaming agents, processing aids, surfactants, and other conventional additives. For example, wetting additives may be added to the modified curative blends of the invention to more effectively disperse the pigment(s). Suitable wetting agents are available from Byk-Chemle and Crompton Corporation, among others.

Antioxidants, stabilizers, softening agents, plasticizers, including internal and external plasticizers, impact modifiers, foaming agents, density-adjusting fillers, reinforcing materials, and compatibilizers may also be added to any composition of the invention. Those of ordinary skill in the art are aware of the purpose of these additives and the amounts that should be employed to fulfill those purposes.

Catalysts

A catalyst may also be employed to promote the reaction between the prepolymer and the curing agent. Suitable catalysts include, but are not limited to bismuth catalyst; zinc octoate; stannous octoate; tin catalysts such as bis-butyltin dilaurate (DABCO® T-12 manufactured by Air Products and Chemicals, Inc.), bis-butyltin diacetate (DABCO® T-1); stannous octoate (DABCO® T-9); tin (II) chloride, tin (IV) chloride, bis-butyltin dimethoxide (FASCAT®-4211), dimethyl-bis[1-oxonedecyl)oxy]stannane (FORMEZ® UL-28), di-n-octyltin bis-isooctyl mercaptoacetate (FORMEZ® UL-29); amine catalysts such as triethylenediamine (DABCO® 33-LV), triethylamine, and tributylamine; organic acids such as oleic acid and acetic acid; delayed catalysts such as POLYCAT™ SA-1, POLYCAT™ SA-2, POLYCAT™, and the like; and mixtures thereof. In one embodiment, the catalyst is bis-butyltin dilaurate. When the composition is foamed, the catalysts may also include sodium salts and potassium salts of carboxylic acids, such as sodium acetate, potassium acetate, sodium oleate, and potassium oleate.

If used, the catalyst is preferably added in an amount sufficient to catalyze the reaction of the components in the reactive mixture. In one embodiment, the catalyst is present in an amount from about 0.001 percent to about 5 percent by weight of the composition. For example, when using a tin catalyst, such as bis-butyltin dilaurate, the catalyst is preferably present in an amount from about 0.005 percent to about 1 percent. In another embodiment, the catalyst is present in an amount of about 0.05 weight percent or greater. In another embodiment, the catalyst is present in an amount of about 0.5 weight percent or greater.

Use of low levels of tin catalysts, typically from about 0 to about 0.04 weight percent of the total composition, requires high temperatures to achieve a suitable reaction rate, which may result in degradation of the prepolymer. Increasing the amount of catalysts to unconventional high levels enables the reduction in process temperatures while retaining comparable cure stages. Use of the higher catalyst level also allows the mixing speeds to be reduced. Thus, in one embodiment, the tin catalyst is present in an amount from about 0.01 percent to about 0.55 percent by weight of the composition. In another embodiment, about 0.05 percent to about 0.4 percent of tin catalyst is present in the composition. In yet another embodiment, the tin catalyst is present in an amount from about 0.1 percent to about 0.25 percent.

Density-Adjusting Filler(s)

Fillers may be added to the polyurethane and polyurea compositions of the invention to affect rheological and mixing properties, the specific gravity (i.e., density-modifying fillers), the modulus, the tear strength, reinforcement, and the like. The fillers are generally inorganic, and suitable fillers include numerous metals, metal oxides and salts, such as zinc oxide and tin oxide, as well as barium sulfate, zinc sulfate, calcium carbonate, zinc carbonate, barium carbonate, clay, tungsten, tungsten carbide, an array of silicas, regrind (recycled core material typically ground to about 30 mesh particle), high-Mooney-viscosity rubber regrind, and mixtures thereof.

For example, the compositions of the invention can be reinforced by blending with a wide range of density-adjusting fillers, e.g., ceramics, glass spheres (solid or hollow, and filled or unfilled), and fibers, inorganic particles, and metal particles, such as metal flakes, metallic powders, oxides, and derivatives thereof, as is known to those with skill in the art. The selection of such filler(s) is dependent upon the type of golf ball desired, i.e., one-piece, two-piece, multi-component, or wound, as will be more fully detailed below. Generally, the filler will be inorganic, having a density of greater than 4 g/cc, and will be present in amounts between about 5 and about 65 weight percent based on the total weight of the polymer components included in the layer(s) in question. Examples of useful fillers include zinc oxide, barium sulfate, calcium oxide, calcium carbonate, and silica, as well as other known corresponding salts and oxides thereof.

Fillers may also be used to modify the weight of the core or at least one additional layer for specialty balls, e.g., a lower weight ball is preferred for a player having a low swing speed.

Blowing or Foaming Agent(s)

The compositions of the invention may be foamed by the addition of the at least one physical or chemical blowing or foaming agent. The use of a foamed polymer allows the golf ball designer to adjust the density or mass distribution of the ball to adjust the angular moment of inertia, and, thus, the spin rate and performance of the ball. Foamed materials also offer a potential cost savings due to the reduced use of polymeric material.

Blowing or foaming agents useful include, but are not limited to, organic blowing agents, such as azobisformamide; azobisisobutyronitrile; diazoaminobenzene; N,N-dimethyl-N,N-dinitroso terephthalamide; N,N-dinitrosopentamethylene-tetramine; benzenesulfonyl-hydrazide; benzene-1,3-disulfonyl hydrazide; diphenylsulfon-3-3, disulfonyl hydrazide; 4,4′-oxybis benzene sulfonyl hydrazide; p-toluene sulfonyl semicarbizide; barium azodicarboxylate; butylamine nitrile; nitroureas; trihydrazino triazine; phenyl-methyl-uranthan; p-sulfonhydrazide; peroxides; and inorganic blowing agents such as ammonium bicarbonate and sodium bicarbonate. A gas, such as air, nitrogen, carbon dioxide, etc., can also be injected into the composition during the injection molding process.

Additionally, a foamed composition of the present invention may be formed by blending microspheres with the composition either during or before the molding process. Polymeric, ceramic, metal, and glass microspheres are useful in the invention, and may be solid or hollow and filled or unfilled. In particular, microspheres up to about 1000 micrometers in diameter are useful. Furthermore, the use of liquid nitrogen for foaming, as disclosed in U.S. Pat. No. 6,386,992, which is incorporated by reference herein, may produce highly uniform foamed compositions for use in the present invention.

Light Stabilizers and Coloring Agents

The compositions of the invention may include both saturated and unsaturated components. And, while the use of only saturated components aids in avoiding the yellowing over time that occurs with unsaturated components, the use of various UV absorbers and light stabilizers to any of the above compositions may help to also maintain the tensile strength, elongation, and color stability. The use of light stabilizing components also may assist in preventing cover surface fractures due to photodegredation. As such, the compositions of the invention may contain at least one light stabilizing component to prevent significant yellowing from unsaturated components contained therein. As used herein, light stabilizer may be understood to include hindered amine light stabilizers, ultraviolet (UV) absorbers, and antioxidants.

Suitable light stabilizers include, but are not limited to, TINUVIN® 292, TINUVIN® 328, TINUVIN® 213, TINUVIN® 765, TINUVIN® 770 and TINUVIN® 622. TINUVIN® products are available from Ciba Specialty Chemicals of Tarrytown, N.Y. In one embodiment, the light stabilizer is UV absorber TINUVIN® 328, which is useful with aromatic compounds. In another embodiment, hindered amine light stabilizer TINUVIN® 765 is used with aromatic or aliphatic compounds. In addition, TINUVIN® 292 may also be used with the aromatic or aliphatic compositions of the invention.

As discussed above, dyes, as well as optical brighteners and fluorescent pigments may also be included in the golf ball covers produced with polymers formed according to the present invention. Such additional ingredients may be added in any amounts that will achieve their desired purpose.

Composition Blends

The compositions of the invention preferably include from about 1 percent to about 100 percent polyurethane-based or polyurea-based polymers, however, the compositions may also be blended with other materials. In one embodiment, the composition contains about 10 percent to about 90 percent polyurethane-based or polyurea-based polymer, preferably from about 10 percent to about 75 percent polyurethane-based or polyurea-based polymer, and contains about 90 percent to 10 percent, more preferably from about 90 percent to about 25 percent other polymers and/or other materials as described below. Unless otherwise stated herein, all percentages are given in percent by weight of the total composition of the golf ball layer in question.

Other polymeric materials suitable for blending with the compositions of the invention include castable thermoplastics, cationic and anionic urethane ionomers and urethane epoxies, polyurethane ionomers, polyurea ionomers, epoxy resins, polyethylenes, polyamides and polyesters, polycarbonates, polyacrylin, siloxanes and epoxy resins or their blends, and mixtures thereof. One of ordinary skill in the art would be well aware of methods to blend the polymeric materials with the composition of the invention.

Examples of suitable urethane ionomers are disclosed in U.S. Pat. No. 5,692,974, the disclosure of which is hereby incorporated by reference in its entirety. Other examples of suitable polyurethanes are described in U.S. Pat. No. 5,334,673, the entire disclosure of which is incorporated by reference herein. Examples of suitable polyureas used to form the polyurea ionomer listed above are discussed in U.S. Pat. No. 5,484,870. In particular, the polyureas of U.S. Pat. No. 5,484,870 are prepared by reacting a polyisocyanate and a polyamine curing agent to yield polyurea, which are distinct from the polyureas of the present invention which are formed from a polyurea prepolymer and curing agent. Examples of suitable polyurethanes cured with epoxy group containing curing agents are disclosed in U.S. Pat. No. 5,908,358. The disclosures of the above patents are incorporated herein by reference in their entirety.

Golf Ball Construction

The compositions of the present invention may be used with any type of ball construction including, but not limited to, one-piece, two-piece, three-piece, and four-piece designs, a double core, a double cover, an intermediate layer(s), a multilayer core, and/or a multi-layer cover depending on the type of performance desired of the ball. That is, the compositions of the invention may be used in a core, an intermediate layer, and/or a cover of a golf ball, each of which may have a single layer or multiple layers. As used herein, the term “multilayer” means at least two layers.

For instance, the core may be a one-piece core or a multilayer core, both of which may be solid, semi-solid, hollow, fluid-filled, or powder-filled. A multilayer core is one that has an innermost component with an additional core layer or additional core layers disposed thereon. In addition, when the golf ball of the present invention includes an intermediate layer, this layer may be incorporated with a single or multilayer cover, a single or multi-piece core, with both a single layer cover and core, or with both a multilayer cover and a multilayer core. The intermediate layer may be an inner cover layer or outer core layer, or any other layer(s) disposed between the inner core and the outer cover of a golf ball. As with the core, the intermediate layer, if included, and the cover layer may include a plurality of layers. It will be appreciated that any number or type of intermediate and cover layers may be used, as desired. For example, the intermediate layer may also be a tensioned elastomeric material wound around a solid, semi-solid, hollow, fluid-filled, or powder-filled center.

Non-limiting examples of suitable types of ball constructions that may be used with the present invention include those described in U.S. Pat. Nos. 6,056,842, 5,688,191, 5,713,801, 5,803,831, 5,885,172, 5,919,100, 5,965,669, 5,981,654, 5,981,658, and 6,149,535, as well as in Publication Nos. US2001/0009310 A1, US2002/0025862, and US2002/0028885. The entire disclosures of these patents and published patent applications are incorporated by reference herein.

Layer Compositions

Golf Ball Core Layer(s)

The cores of the golf balls formed according to the invention may be solid, semi-solid, hollow, fluid-filled or powder-filled, one-piece or multi-component cores. The term “semi-solid” as used herein refers to a paste, a gel, or the like. Any core material known to one of ordinary skill in that art is suitable for use in the golf balls of the invention. Suitable core materials include thermoset materials, such as rubber, styrene butadiene, polybutadiene, isoprene, polyisoprene, trans-isoprene, as well as thermoplastics such as ionomer resins, polyamides or polyesters, and thermoplastic and thermoset polyurethane elastomers. As mentioned above, the polyurethane-based or polyurea-based compositions of the present invention may also be incorporated into a core layer of a golf ball

As used herein, the terms core and center are generally used interchangeably to reference the innermost component of the ball. In some embodiments, however, the term “center” is used when there are multiple core layers, i.e., a center and an outer core layer.

The core may have a diameter ranging from about 0.09 inches to about 1.65 inches. In one embodiment, the diameter of the core of the present invention is about 1.2 inches to about 1.630 inches. In another embodiment, the diameter of the core is about 1.3 inches to about 1.6 inches, preferably from about 1.39 inches to about 1.6 inches, and more preferably from about 1.5 inches to about 1.6 inches. In yet another embodiment, the core has a diameter of about 1.55 inches to about 1.65 inches. In one embodiment, the core diameter is about 1.59 inches or greater. In another embodiment, the diameter of the core is about 1.64 inches or less.

When the core includes an inner core layer and an outer core layer, the inner core layer is preferably about 0.9 inches or greater and the outer core layer preferably has a thickness of about 0.1 inches or greater. In one embodiment, the inner core layer has a diameter from about 0.09 inches to about 1.2 inches and the outer core layer has a thickness from about 0.1 inches to about 0.8 inches. In yet another embodiment, the inner core layer diameter is from about 0.095 inches to about 1.1 inches and the outer core layer has a thickness of about 0.20 inches to about 0.03 inches.

Golf Ball Intermediate Layer(s)

When the golf ball of the present invention includes an intermediate layer, such as an inner cover layer or outer core layer, i.e., any layer(s) disposed between the inner core and the outer cover of a golf ball, this layer can include any materials known to those of ordinary skill in the art including thermoplastic and thermosetting materials. In one embodiment, the intermediate layer is formed, at least in part, from the polyurethane-based or polyurea-based composition of the invention.

The intermediate layer(s) may also be formed, at least in part, from one or more homopolymeric or copolymeric materials, such as ionomers, primarily or fully non-ionomeric thermoplastic materials, vinyl resins, polyolefins, polyurethanes, polyureas, such as those disclosed in U.S. Pat. No. 5,484,870, polyamides, acrylic resins and blends thereof, olefinic thermoplastic rubbers, block copolymers of styrene and butadiene, isoprene or ethylene-butylene rubber, copoly(ether-amide), such as PEBAX, sold by Atofina Chemicals, Inc. of Philadelphia, Pa., polyphenylene oxide resins or blends thereof, and thermoplastic polyesters.

For example, the intermediate layer may be formed of low acid ionomers, such as those described in U.S. Pat. Nos. 6,506,130 and 6,503,156, high acid ionomers, highly neutralized polymers, such as those disclosed in U.S. Patent Publication Nos. 2001/0018375 and 2001/0019971, or mixtures thereof. The intermediate layer may also be formed from the compositions as disclosed in U.S. Pat. No. 5,688,191. The entire disclosures of these patents and publications are incorporated herein by express reference thereto.

The range of thicknesses for an intermediate layer of a golf ball is large because of the vast possibilities when using an intermediate layer, i.e., as an outer core layer, an inner cover layer, a wound layer, a moisture/vapor barrier layer. When used in a golf ball of the invention, the intermediate layer, or inner cover layer, may have a thickness about 0.3 inches or less. In one embodiment, the thickness of the intermediate layer is from about 0.002 inches to about 0.1 inches, preferably about 0.01 inches or greater. In another embodiment, the intermediate layer thickness is about 0.05 inches or less, more preferably about 0.01 inches to about 0.045 inches.

Golf Ball Cover(s)

The cover provides the interface between the ball and a club. Properties that are desirable for the cover are good moldability, high abrasion resistance, high impact resistance, high tear strength, high resilience, and good mold release, among others.

The cover layer may be formed, at least in part, from the polyurethane-based or polyurea-based composition of the invention. The cover layer(s) may also be formed from composition blends as discussed above. For example, in one embodiment, at least one cover layer is formed from a blend of about 10 percent to about 90 percent of the polyurethane-based or polyurea-based material of the invention, preferably saturated, and about 90 percent to about 10 percent other polymers and/or other materials. In yet another embodiment, the cover compositions include from about 10 percent to about 75 percent of a polyurea-based material and about 90 percent to about 25 percent other polymers and/or other materials.

When the polyurethane-based or polyurea-based compositions of the invention are incorporated into a core or intermediate/inner cover layer, the cover compositions may include one or more homopolymeric or copolymeric materials as discussed in the section above pertaining to the intermediate layer. The cover may also be at least partially formed from the polybutadiene reaction product discussed above with respect to the core.

The cover typically has a thickness to provide sufficient strength, good performance characteristics, and durability. In one embodiment, the cover thickness is from about 0.02 inches to about 0.12 inches, preferably about 0.1 inches or less. In another embodiment, the cover thickness is about 0.05 inches or less, preferably from about 0.02 inches to about 0.05 inches, and more preferably about 0.02 inches and about 0.045 inches.

Methods of Forming Layers

The golf balls of the invention may be formed using a variety of application techniques such as compression molding, flip molding, injection molding, retractable pin injection molding, reaction injection molding (RIM), liquid injection molding (LIM), casting, vacuum forming, powder coating, flow coating, spin coating, dipping, spraying, and the like. Conventionally, compression molding and injection molding are applied to thermoplastic materials, whereas RIM, liquid injection molding, and casting are employed on thermoset materials. These and other manufacture methods are disclosed in U.S. Pat. Nos. 6,207,784 and 5,484,870, the disclosures of which are incorporated herein by reference in their entirety. One skilled in the art would appreciate that the molding method used for a particular layer may be determined at least partially by the properties of the composition. For example, casting may be preferred when the material is thermoset, whereas compression molding or injection molding may be preferred for thermoplastic compositions.

The cores of the invention may be formed by any suitable method known to those of ordinary skill in art. When the cores are formed from a thermoset material, compression molding is a particularly suitable method of forming the core. In a thermoplastic core embodiment, on the other hand, the cores may be injection molded. Furthermore, U.S. Pat. Nos. 6,180,040 and 6,180,722 disclose methods of preparing dual core golf balls. The disclosures of these patents are hereby incorporated by reference in their entirety.

The intermediate layer may also be formed from using any suitable method known to those of ordinary skill in the art. For example, an intermediate layer may be formed by blow molding and covered with a dimpled cover layer formed by injection molding, compression molding, casting, vacuum forming, powder coating, and the like.

The polyurethane-based and polyurea-based materials of the invention may be applied over an inner ball using a variety of application techniques such as spraying, compression molding, dipping, spin coating, casting, or flow coating methods that are well known in the art. In one embodiment, the polyurea-based materials are formed over the core using a combination of casting and compression molding. Because the prepolymer-curative ratio plays a large role in determining whether a composition of the invention will be thermoplastic or thermoset, however, the method of molding the compositions of the invention onto the ball will vary depending on the nature of the composition. For example, thermoplastic polyurea compositions of the present invention may be used to make thermoplastic pellets that can be molded onto the ball by injection molding or compression molding. Thermoset polyurea compositions may be cast onto the ball. In addition, both the thermoplastic and thermoset polyurea compositions of the present invention also may be formed around the core using reaction injection molding (RIM) and liquid injection molding (LIM) techniques.

U.S. Pat. No. 5,733,428, the entire disclosure of which is hereby incorporated by reference, discloses a method for forming a polyurethane-based cover on a golf ball core. Because this method relates to the use of both casting thermosetting and thermoplastic material as the golf ball cover, wherein the cover is formed around the core by mixing and introducing the material in mold halves, the polyurea-based compositions may also be used employing the same casting process.

Similarly, U.S. Pat. No. 5,006,297 and U.S. Pat. No. 5,334,673 both also disclose suitable molding techniques that may be utilized to apply the polyurethane-based and polyurea-based compositions of the invention. However, the method of the invention is not limited to the use of these techniques; other methods known to those skilled in the art may also be employed. For instance, other methods for holding the ball core may be utilized instead of using a partial vacuum.

Golf Ball Post-Processing

The golf balls of the present invention may be painted, coated, or surface treated for further benefits. For example, golf balls may be coated with coating materials, such as urethanes, urethane hybrids, epoxies, polyesters and acrylics. If desired, more than one coating layer can be used. The coating layer(s) may be applied by any suitable method known to those of ordinary skill in the art. In one embodiment, the coating layer(s) is applied to the golf ball cover by an in-mold coating process, such as described in U.S. Pat. No. 5,849,168, which is incorporated in its entirety by reference herein.

Golf Ball Properties

Properties such as core diameter, intermediate layer thickness and cover layer thickness (discussed earlier), hardness, and compression have been found to effect play characteristics such as spin, initial velocity and feel of the present golf balls.

Golf Ball Component Dimensions

Dimensions of golf ball components, i.e., thickness and diameter, may vary depending on the desired properties. For the purposes of the invention, any layer thickness may be employed. For example, the overall golf ball size may range from about 1.68 inches to about 1.8 inches, preferably about 1.68 inches to about 1.76 inches, and more preferably about 1.68 inches to about 1.74 inches is most preferred. Larger overall diameters are also contemplated (e.g., up to about 1.95 inches).

Hardness

Most golf balls consist of layers having different hardnesses, e.g., hardness gradients, to achieve desired performance characteristics. The present invention contemplates golf balls having hardness gradients between layers, as well as those golf balls with layers having the same hardness.

It should be understood, especially to one of ordinary skill in the art, that there is a fundamental difference between “material hardness” and “hardness, as measured directly on a golf ball.” Material hardness is defined by the procedure set forth in ASTM-D2240 and generally involves measuring the hardness of a flat “slab” or “button” formed of the material of which the hardness is to be measured. Hardness, when measured directly on a golf ball (or other spherical surface) is a completely different measurement and, therefore, results in a different hardness value. This difference results from a number of factors including, but not limited to, ball construction (i.e., core type, number of core and/or cover layers, etc.), ball (or sphere) diameter, and the material composition of adjacent layers. It should also be understood that the two measurement techniques are not linearly related and, therefore, one hardness value cannot easily be correlated to the other.

For example, the cores of the present invention may have varying hardnesses depending on the particular golf ball construction. In one embodiment, the core hardness is at least about 15 Shore A, preferably about 30 Shore A, as measured on a formed sphere. In another embodiment, the core has a hardness of about 50 Shore A to about 90 Shore D. In yet another embodiment, the hardness of the core is about 80 Shore D or less. Preferably, the core has a hardness about 30 to about 65 Shore D, and more preferably, the core has a hardness about 35 to about 60 Shore D.

The intermediate layer(s) of the present invention may also vary in hardness depending on the specific construction of the ball. In one embodiment, the hardness of the intermediate layer is about 30 Shore D or greater. In another embodiment, the hardness of the intermediate layer is about 90 Shore D or less, preferably about 80 Shore D or less, and more preferably about 70 Shore D or less. In yet another embodiment, the hardness of the intermediate layer is about 50 Shore D or greater, preferably about 55 Shore D or greater. In one embodiment, the intermediate layer hardness is from about 55 Shore D to about 65 Shore D. The intermediate layer may also be about 65 Shore D or greater.

As with the core and intermediate layers, the cover hardness may vary depending on the construction and desired characteristics of the golf ball. The ratio of cover hardness to inner ball hardness is a primary variable used to control the aerodynamics of a ball and, in particular, the spin of a ball. In general, the harder the inner ball, the greater the driver spin and the softer the cover, the greater the driver spin.

For example, when the intermediate layer is intended to be the hardest point in the ball, e.g., about 50 Shore D to about 75 Shore D, the cover material may have a hardness of about 20 Shore D or greater, preferably about 25 Shore D or greater, and more preferably about 30 Shore D or greater, as measured on the slab. In another embodiment, the cover itself has a hardness of about 30 Shore D or greater. In particular, the cover may be from about 30 Shore D to about 70 Shore D. In one embodiment, the cover has a hardness of about 40 Shore D to about 65 Shore D, and in another embodiment, about 40 Shore to about 55 Shore D. In another aspect of the invention, the cover has a hardness less than about 45 Shore D, preferably less than about 40 Shore D, and more preferably about 25 Shore D to about 40 Shore D. In one embodiment, the cover has a hardness from about 30 Shore D to about 40 Shore D.

Compression

Compression values are dependent on the diameter of the component being measured. The Atti compression of the core, or portion of the core, of golf balls prepared according to the invention is preferably less than about 80, more preferably less than about 75. As used herein, the terms “Atti compression” or “compression” are defined as the deflection of an object or material relative to the deflection of a calibrated spring, as measured with an Atti Compression Gauge, that is commercially available from Atti Engineering Corp. of Union City, N.J. Atti compression is typically used to measure the compression of a golf ball. In another embodiment, the core compression is from about 40 to about 80, preferably from about 50 to about 70. In yet another embodiment, the core compression is preferably below about 50, and more preferably below about 25.

In an alternative, low compression embodiment, the core has a compression less than about 20, more preferably less than about 10, and most preferably, 0. As known to those of ordinary skill in the art, however, the cores generated according to the present invention may be below the measurement of the Atti Compression Gauge.

In one embodiment, golf balls of the invention preferably have an Atti compression of about 55 or greater, preferably from about 60 to about 120. In another embodiment, the Atti compression of the golf balls of the invention is at least about 40, preferably from about 50 to 120, and more preferably from about 60 to 100. In yet another embodiment, the compression of the golf balls of the invention is about 75 or greater and about 95 or less. For example, a preferred golf ball of the invention may have a compression from about 80 to about 95.

Coefficient of Restitution

The present invention contemplates golf balls having CORs from about 0.700 to about 0.850 at an inbound velocity of about 125 ft/sec. In one embodiment, the COR is about 0.750 or greater, preferably about 0.780 or greater. In another embodiment, the ball has a COR of about 0.800 or greater. In yet another embodiment, the COR of the balls of the invention is about 0.800 to about 0.815.

In addition, the inner ball preferably has a COR of about 0.780 or more. In one embodiment, the COR is about 0.790 or greater.

Flexural Modulus

Accordingly, it is preferable that the golf balls of the present invention have an intermediate layer with a flexural modulus of about 500 psi to about 500,000 psi. More preferably, the flexural modulus of the intermediate layer is about 1,000 psi to about 250,000 psi. Most preferably, the flexural modulus of the intermediate layer is about 2,000 psi to about 200,000 psi. The flexural modulus is measured in accordance with ASTM D-6272-98.

The flexural modulus of the cover layer is preferably about 2,000 psi or greater, and more preferably about 5,000 psi or greater. In one embodiment, the flexural modulus of the cover is from about 10,000 psi to about 150,000 psi. More preferably, the flexural modulus of the cover layer is about 15,000 psi to about 120,000 psi. Most preferably, the flexural modulus of the cover layer is about 18,000 psi to about 110,000 psi. In another embodiment, the flexural modulus of the cover layer is about 100,000 psi or less, preferably about 80,000 or less, and more preferably about 70,000 psi or less. For example, the flexural modulus of the cover layer may be from about 10,000 psi to about 70,000 psi, from about 12,000 psi to about 60,000 psi, or from about 14,000 psi to about 50,000 psi.

In one embodiment, when the cover layer has a hardness of about 50 Shore D to about 60 Shore D, the cover layer preferably has a flexural modulus of about 55,000 psi to about 65,000 psi.

In one embodiment, the ratio of the flexural modulus of the intermediate layer to the cover layer is about 0.003 to about 50. In another embodiment, the ratio of the flexural modulus of the intermediate layer to the cover layer is about 0.006 to about 4.5. In yet another embodiment, the ratio of the flexural modulus of the intermediate layer to the cover layer is about 0.11 to about 4.5.

In one embodiment, the compositions of the invention are used in a golf ball with multiple cover layers having essentially the same hardness, but differences in flexural moduli. In this aspect of the invention, the difference between the flexural moduli of the two cover layers is preferably about 5,000 psi or less. In another embodiment, the difference in flexural moduli is about 500 psi or greater. In yet another embodiment, the difference in the flexural moduli between the two cover layers, wherein at least one is reinforced is about 500 psi to about 10,000 psi, preferably from about 500 psi to about 5,000 psi. In one embodiment, the difference in flexural moduli between the two cover layers formed of unreinforced or unmodified materials is about 1,000 psi to about 2,500 psi.

Moisture Vapor Transmission

The moisture vapor transmission of a golf ball portion formed from the compositions of the invention may be expressed in terms of absorption, e.g., weight gain or size gain over a period of time at a specific conditions, and transmission, e.g., moisture vapor transmission rate (MVTR) according to ASTM F 1249-90 and ASTM E96-00. MVTR refers to the mass of water vapor that diffused into a material of a given thickness per unit area per unit time at a specific temperature and humidity differential. For example, weight changes of a golf ball portion monitored over a period of seven weeks in 100 percent relative humidity and 72° F. help to demonstrate which balls have better water resistance. In one embodiment, the golf ball portions of the invention have a weight gain of about 0.15 grams or less after seven weeks. In another embodiment, the golf balls of the invention have a weight gain of about 0.13 grams or less after a seven-week storage period. In still another embodiment, the weight gain of the golf balls of the invention is about 0.09 grams or less after seven weeks. In yet another embodiment, the weight gain is about 0.06 grams or less after a seven-week period. The golf balls of the invention preferably have a weight gain of about 0.03 grams or less over a seven-week storage period.

Size gain may also be used as an indicator of water resistance. That is, the more water a golf ball takes on, the larger a golf ball becomes due to the water enclosed beneath the outermost layer of the golf ball portion. Thus, the golf balls of the invention preferably have no appreciable size gain. In one embodiment, the size gain of the golf balls of the invention after a seven-week period is about 0.001 inches or less.

MVTR of a golf ball, or portion thereof, may be about 2 g/(m2×day) or less, such as about 0.45 to about 0.95 g/(m2×day), about 0.01 to about 0.9 g/(m2×day) or less, at 38° C. and 90 percent relative humidity.

Light Stability

The light stability of the cover may be quantified by the difference in yellowness index (ΔYI), i.e., yellowness measured after a predetermined exposure time—yellowness before exposure. In one embodiment, the ΔYI is about 90 or less after 8 days of exposure, preferably about 70 or less after 8 days of exposure, and more preferably about 60 or less after 8 days of exposure. In one embodiment, the ΔYI is about 50 or less after 8 days of exposure, and more preferably about 40 or less after 8 days of exposure.

The difference in the b chroma dimension (Δb*, yellow to blue) is also a way to quantify the light stability of the cover. In one embodiment, the Δb* is about 40 or less after 8 days of exposure, preferably about 30 or less after 8 days of exposure, and more preferably about 20 or less after 8 days of exposure. In one embodiment, the Δb* is about 15 or less after 8 days of exposure, preferably about 13 or less after 8 days of exposure.

In this aspect of the invention, golf ball covers formed with the compositions of the invention, e.g., those polyurethane-based and polyurea-based compositions including a tertiary isocyanate or durene isocyanate, have improved light stability over that of a similar composition including an aromatic isocyanate. For example, the compositions of the invention have a difference in yellow index that is about 40 percent (or less) of the ΔYI of a similar composition including an aromatic isocyanate. In one embodiment, the ΔYI of a composition of the invention is about 30 percent or less, preferably about 25 percent or less, and more preferably about 20 percent or less, of the ΔYI of its aromatic counterpart. Likewise, the difference in b chroma dimension for a composition of the invention is preferably about half of the Δb* of its aromatic counterpart. In one embodiment, the Δb* of the compositions of the invention is about 40 percent or less, preferably about 35 percent or less, and more preferably about 30 percent or less, of its aromatic counterpart.

Durability

The durability of the golf balls of the invention can be measured in terms of impact durability, i.e., failure after a specified number of hits, and by using a cold crack test at a specified temperature. In one embodiment, the impact durability of covers made from the polyurethane-based and polyurea-based compositions of the invention is no failure after 300 hits. In another embodiment, the impact durability is no failure after 400 hits. Likewise, a cold crack test at 15° F. preferably results in no failures. In one embodiment, a cold crack test at 10° F. results in no failures. In yet another embodiment, a cold crack test at 5° F. results in no failures.

### EXAMPLES

The following non-limiting examples are merely illustrative of particular embodiments of the present invention, and are not to be construed as limiting the invention, the scope of which is defined by the appended claims. Percent is by weight unless otherwise indicated.

### Example 1

### Polyurea Composition

A polyurea composition (Formulation 1) was formed using a 1:1 equivalent of m-TMXDI prepolymer and a curative blend. The prepolymer is the reaction product of meta-tetramethylxylene diisocyanate and polyether amine Jeffamine D-2000 at 7.03 percent NCO (manufactured by PPG Industries). The curative blend includes Ethacure LC (an aromatic diamine (diethyltoluene diamine) manufactured by Albemarle Corporation) and 3.5 percent of HCC-19584, which is a white-blue color dispersion manufactured by the Polyone Corporation (formerly the Harwick Chemical Corporation).

In addition, a hybrid polyurethane-polyurea composition (Formulation 2) was formed using a 1:1 equivalent of m-TMXDI prepolymer and a curative blend. The prepolymer is the reaction product of meta-tetramethylxylene diisocyanate and polytetramethylene ether glycol PTMEG 2000 at 7.94 percent NCO (manufactured by PPG Industries). The curative blend includes Ethacure LC and 3.5 percent of HCC-19584.

Finally, a control composition was formed using an aromatic isocyanate (4,4′-diphenylmethane diisocyanate (MDI)) and polytetramethyletherglycol (PTMEG) and cured with Ethacure 300.

Golf balls were constructed having polybutadiene core, ionomer resin inner cover layers and thin covers formulated from the compositions above following the teachings of U.S. Pat. No. 5,733,428. The balls were then subjected to durability testing and ultraviolet exposure testing. In particular, the golf balls were tested according to ASTM G 53-88 “Standard Practice for Operating Light and Water-Exposure Apparatus (Fluorescent UV-Condensation Type) for Exposure of Nonmetallic Materials.” The physical properties and the ball performance results are listed in Table 1, wherein Δb* equals the difference in the b chroma dimension (yellow to blue) and ΔYI is the difference in the yellowness index. Color was measured before exposure and after each time cycle using a BYK-Gardner Model TCS II sphere type Spectrophotometer equipped with a 25-mm port. A D65/10′ illumination was used in the specular reflectance included mode.

TABLE 1
PHYSICAL PROPERTIES

| Ball Properties/ | | | | Aromatic |
|---|---|---|---|---|
| Ball Types | | Formulation 1 | Formulation 2 | Control |
| Compression | | 83 | 85 | 82 |
| COR @ 125 ft/sec | | 0.807 | 0.807 | 0.806 |
| Cover | Shore D | 60 | 60 | 59 |
| Hardness | Shore C | 81 | 82 | 81 |

| | | | |
|---|---|---|---|
| Impact Durability | No failure | No failure | No failure |
| (400 hits) | | | |
| Cold Crack Test, 5° F. | No failure | No failure | No failure |

Light Stability (8 Days QUV Test)

| | | | |
|---|---|---|---|
| ΔYI | 20.5 | 24.3 | 92.4 |
| Δb* | 11.0 | 13.6 | 36.7 |

As demonstrated in the table above, the golf ball covers formed of the compositions of the invention, i.e., including a tertiary isocyanate, have compression values, COR values, hardness values, and durability properties that are comparable to the aromatic control. The light stability, however, of the golf ball covers formed with Formulations 1 and 2 is improved over that of the aromatic control.

### Example 2

### Polyurea Composition Including a Durene Diisocyanate

A polyurea composition may be formed using a 1:1 equivalent of durene diisocyanate (2,3,5,6-tetramethyl-1,4-diisocyanatobenzene) prepolymer and a curative blend. In particular, the prepolymer may be the reaction product of 2,3,5,6-tetramethyl-1,4-diisocyanatobenzene and polyether amine Jeffamine D-2000. The curative blend may incorporate an aliphatic or aromatic diamine and may also include a whitening agent.

The compression, COR, hardness, and durability is preferably comparable to a composition including the same ingredients but substituting the durene diisocyanate for an aromatic diisocyanate. The light stability is preferably improved over the aromatic control, e.g., the ΔYI is preferably about 50 percent or less of the ΔYI of the aromatic control.

### Example 3

### Polyurethane Composition Including a Durene Diisocyanate

A polyurethane composition may be formed using a 1:1 equivalent of durene diisocyanate (2,3,5,6-tetramethyl-1,4-diisocyanatobenzene) prepolymer and a curative blend. In particular, the prepolymer may be the reaction product of 2,3,5,6-tetramethyl-1,4-diisocyanatobenzene and polytetramethylene ether glycol PTMEG 2000. The curative blend may incorporate an aliphatic or aromatic polyol and may also include a whitening agent.

The compression, COR, hardness, and durability is preferably comparable to a composition including the same ingredients but substituting the durene diisocyanate for an aromatic diisocyanate. The light stability is preferably improved over the aromatic control, e.g., the ΔYI is preferably about 50 percent or less of the ΔYI of the aromatic control.

### Example 4

### Hybrid Composition Including a Durene Diisocyanate

A hybrid polyurethane-polyurea composition may be formed using a 1:1 equivalent of durene diisocyanate (2,3,5,6-tetramethyl-1,4-diisocyanatobenzene) prepolymer and a curative blend. The prepolymer may be the reaction product of 2,3,5,6-tetramethyl-1,4-diisocyanatobenzene) and polytetramethylene ether glycol PTMEG 2000. The curative blend may include an aliphatic diamine or an aromatic diamine, such as Ethacure LC. In addition, the curative blend may include a whitening agent.

The compression, COR, hardness, and durability is preferably comparable to a composition including the same ingredients but substituting the durene diisocyanate for an aromatic diisocyanate. The light stability is preferably improved over the aromatic control, e.g., the ΔYI is preferably about 50 percent or less of the ΔYI of the aromatic control.

Other than in the operating examples, or unless otherwise expressly specified, all of the numerical ranges, amounts, values and percentages such as those for amounts of materials, times and temperatures of reaction, ratios of amounts, values for molecular weight (whether number average molecular weight (“Mₙ”) or weight average molecular weight (“M_{w}”), and others in the following portion of the specification may be read as if prefaced by the word “about” even though the term “about” may not expressly appear with the value, amount or range. Accordingly, unless indicated to the contrary, the numerical parameters set forth in the following specification and attached claims are approximations that may vary depending upon the desired properties sought to be obtained by the present invention.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements. Furthermore, when numerical ranges of varying scope are set forth herein, it is contemplated that any combination of these values inclusive of the recited values may be used.

The invention described and claimed herein is not to be limited in scope by the specific embodiments herein disclosed, since these embodiments are intended as illustrations of several aspects of the invention. Any equivalent embodiments are intended to be within the scope of this invention. For example, the compositions of the invention may also be used in golf equipment such as putter inserts, golf club heads and portions thereof, golf shoe portions, and golf bag portions. Indeed, various modifications of the invention in addition to those shown and described herein will become apparent to those skilled in the art from the foregoing description. Such modifications are also intended to fall within the scope of the appended claims. All patents and patent applications cited in the foregoing text are expressly incorporate herein by reference in their entirety.

What is claimed is:

1. A golf ball comprising a core and a cover, wherein at least a portion of the golf ball is formed from a composition comprising:
a diisocyanate having the general formula 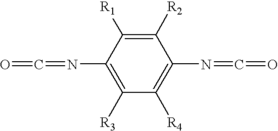
where R₁, R₂, R₃, and R₄ are independently any straight or branched hydrocarbon moiety, acyclic group, cyclic group, heterocyclic group, aromatic group, phenyl group, hydrocarbylene group, or mixtures thereof;
a polyol or amine-terminated compound; and
a curative blend.

2. The golf ball of claim 1, wherein the composition has a difference in yellowness index of about 25 or less after 8 days of ultraviolet exposure.

3. The golf ball of claim 1, wherein the diisocyanate is 2,3,5,6-tetramethyl-1,4-diisocyanatobenzene.

4. The golf ball of claim 1, wherein the polyol and amine-terminated compounds are saturated.

5. The golf ball of claim 1, wherein the curative blend is saturated.

6. A golf ball comprising a core and a cover, wherein the cover is formed from a composition comprising:
a diisocyanate having the structure 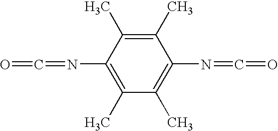
a polyol or amine-terminated compound; and
a curing agent.

7. The golf ball of claim 6, wherein the curing agent is an amine-terminated curing agent.

8. The golf ball of claim 7, wherein the composition comprises an amine-terminated compound and is substantially free of urethane linkages.

9. The golf ball of claim 6, wherein the curing agent is a hydroxy-terminated curing agent, and wherein the composition is substantially free of urea linkages.

10. The golf ball of claim 6, wherein the composition comprises urethane and urea linkages.

11. A golf ball comprising:
a core;
an intermediate layer disposed about the core to form an inner ball; and
a cover, wherein the cover comprises a composition formed from a prepolymer and a curing agent, wherein the prepolymer is the reaction product of a durene diisocyanate and a polyol or amine-terminated compound, and the curing agent is a hydroxy-terminated curing agent or an amine-terminated curing agent.

12. The golf ball of claim 11, wherein the cover has a difference in yellowness index of about 25 or less after 8 days of ultraviolet exposure.

13. The golf ball of claim 11, wherein the cover has a thickness of about 0.02 inches to about 0.035 inches.

14. The golf ball of claim 11, wherein the intermediate layer has a first Shore D hardness and the cover has a second Shore D hardness, and wherein the ratio of second Shore D hardness to the first Shore D hardness is about 0.7 or less.

15. The golf ball of claim 11, wherein the core has a diameter of about 1.55 or greater.

16. The golf ball of claim 11, wherein the intermediate layer comprises at least one thermoplastic ionomeric material.

17. The golf ball of claim 11, wherein the inner ball further comprises a moisture barrier layer.

18. The golf ball of claim 11, wherein the inner ball is surface treated.

19. The golf ball of claim 11, wherein the prepolymer is the reaction product of a durene diisocyanate and an amine-terminated compound.

20. The golf ball of claim 19, wherein the amine-terminated compound is selected from the group consisting of amine-terminated hydrocarbons, amine-terminated polyethers, amine-terminated polyesters, amine-terminated polycaprolactones, amine-terminated polycarbonates, amine-terminated polyamides, and mixtures thereof.
